(19) United States
(12) Patent Application Publication
(10) Pub. No.: US 2009/0040247 A1
(43) Pub. Date: Feb. 12, 2009

(54) MICRO SHIM FOR MOVING COIL ACTUATOR

(76) Inventors: Mark Cato, Escondido, CA (US); Edward A. Neff, Cardiff By The Sea, CA (US); Naoyuki Okada, San Diego, CA (US); Tomast Simunovic, Vista, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/188,111

(22) Filed: Aug. 7, 2008

Related U.S. Application Data
(60) Provisional application No. 60/954,551, filed on Aug. 7, 2007.

(51) Int. Cl. G01D 15/16; G01D 15/18

(52) U.S. Cl. 346/140.1; 346/139 R

(57) ABSTRACT

Apparatuses and methods for changing the friction and stiffness characteristics of a linear guide assembly are disclosed. Micro-shims are strategically added between a carriage of the linear guide assembly and a mating component to increase or decrease the clearance between the carriage and a linear rail of the linear guide assembly.

### CROSS-REFERENCE TO RELATED APPLICATIONS

This application claims priority to U.S. Provisional application No. 60/954,551, filed Aug. 7, 2007, and entitled “Micro-Shim For Moving Coil Actuator,” the entirety of which is incorporated herein by reference.

### BACKGROUND OF THE INVENTION

1. Field of the Invention

This application relates to moving coil actuators, and more particularly to linear guide assemblies used in moving coil actuators.

2. Description of the Related Art

In recent years, it has become known that moving coil actuators may be used to provide precise and accurate forces in many different applications. For many tasks, it may be desirable to impart a particular force against an object or work piece at a predetermined position or location on the object, and at predetermined time intervals. For those tasks which require precision and accuracy during the application of such forces, it is desirable that the magnitude, timing, and location of the applied forces be controlled with precision and accuracy.

Manufacturing high-precision actuators, however, can be time consuming and costly. Moving coil actuators typically use a linear guide assembly to provide reciprocal linear movement of a piston slidably coupled to the guide assembly. To provide accurate and precise movement of an actuator probe or shaft attached to the piston, it is desirable that the linear guide assembly provide smooth and even movement with a minimal amount of friction and resistance. This requires that the components of the linear guide assembly be manufactured with extremely tight tolerances in order to provide the desired smooth motion. For example, when the dimensions of a carriage portion of the guide assembly is not within tolerance values and/or easily deformable, the carriage portion may not glide along a linear rail of the guide assembly in a smooth and/or even fashion. This can prevent accurate and precise movement of a piston and probe attached to the carriage, making the actuator no longer useful for its intended purpose.

In light of the above, there is a need to provide a simple, quick, and cost-effective manner for adjusting the physical characteristics of linear guide assemblies so that they provide smooth linear motion in a consistent fashion.

### BRIEF SUMMARY OF THE INVENTION

The invention addresses the above and other needs by providing a method and apparatus for easily adjusting the physical characteristics of a linear guide assembly so that it can provide smooth and relatively frictionless movement of an object attached to the guide assembly. In one embodiment, the invention utilizes micro-shims for correcting at least one physical characteristic of a linear guide assembly. For example, micro-shims may be used to change stiffness and friction characteristics of a linear guide assembly so that the performance of the actuator falls within acceptable tolerances.

In one exemplary embodiment, the micro-shims comprise indelible ink and are applied to a linear guide assembly by a pen or marker. The micro-shims may be applied to particular locations on a carriage of a linear guide assembly prior to mounting a mating component to the carriage. The particular locations of where the micro-shims are applied may determine which physical characteristics are changed. For example, applying the micro-shims inward from mounting holes on the linear carriage may lower the amount of friction in the assembly. Conversely, applying the micro-shims outward from the mounting holes may increase the stiffness of the assembly so that the carriage does not shake or jiggle as it glides along a linear rail of the assembly. Furthermore, the thickness of a micro-shim may be varied depending upon the number of swipes of the pen or marker on the particular location of the micro-shim. For example, each swipe may add a particular thickness to the micro-shim, such as about 1 to 2 microns. After the micro-shims are applied, the act of clamping a mating component to the carriage may cause the carriage to deform in a desired fashion. This deformation may change one or more physical characteristics of the linear guide assembly so that it provides smoother motion.

### BRIEF DESCRIPTION OF THE DRAWINGS

FIG. 1 illustrates a linear guide assembly according to an exemplary embodiment of the present invention.

FIG. 2A is a cross-sectional front view of a linear guide assembly according to an exemplary embodiment of the present invention.

FIG. 2B is an exploded view of a section of the linear guide assembly of FIG. 2A according to an exemplary embodiment of the present invention.

FIGS. 3A-3C illustrate roll, yaw, and pitch characteristics of a linear guide assembly, respectively, according to an exemplary embodiment of the present invention.

FIGS. 4A-4C are charts illustrating friction variance patterns of linear guide assemblies according to exemplary embodiments of the present invention.

FIG. 5 is a top view of a linear guide assembly with micro-shims applied inward from the linear guide assembly's mounting holes according to an exemplary embodiment of the present invention.

FIG. 6 is an exaggerated cross-sectional front view of a linear guide assembly illustrating use of micro-shims to decrease friction characteristics in the linear guide assembly according to one embodiment of the present invention.

FIG. 7 is a top view of a linear guide assembly with micro-shims applied outward from the linear guide assembly's mounting holes according to an exemplary embodiment of the present invention.

FIG. 8 is an exaggerated cross-sectional front view of a linear guide assembly illustrating use of micro-shims to increase stiffness characteristics in the linear guide assembly according to an exemplary embodiment of the present invention.

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

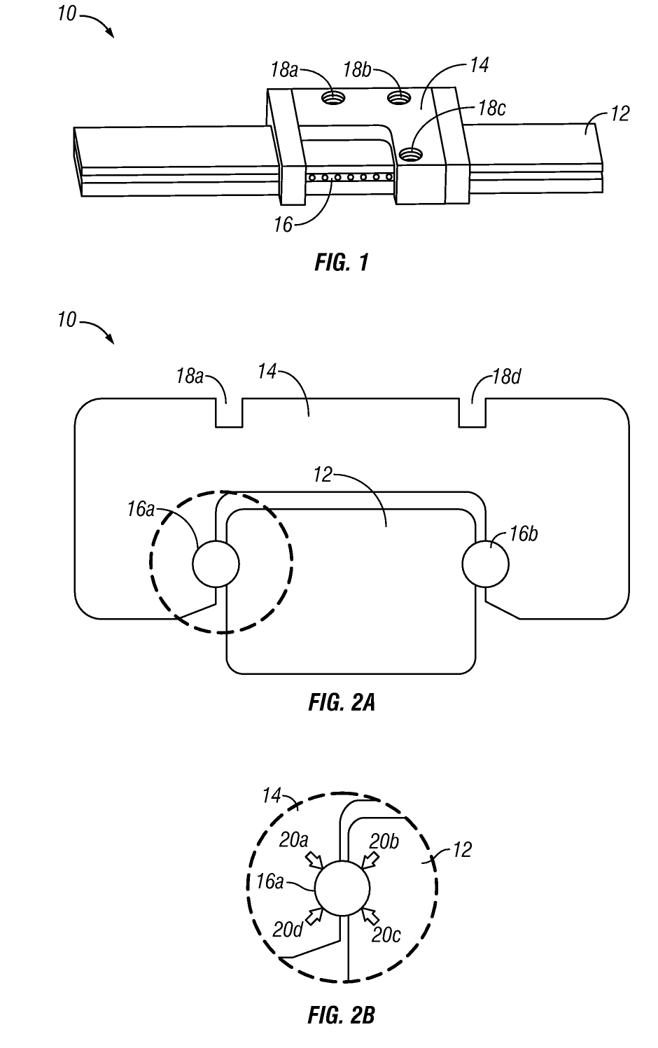

FIG. 1 is a perspective view of an exemplary linear guide assembly 10 in accordance with one embodiment of the present invention. The linear guide assembly 10 includes a rail 12 and a carriage 14 slidably attached to the rail 12. A plurality of bearings 16 are positioned between the rail 12 and the carriage 14 to facilitate movement of the carriage 14 along the rail 12. In one embodiment, the linear guide assembly 10 is used in a moving coil actuator for providing reciprocal linear movement of a piston (not shown) attached to the carriage 14. However, it is understood that the linear guide assembly 10 may be used in other applications as well.

A mating component such as a piston (not shown), may be mounted onto the carriage 14 via mounting holes 18a, 18b, 18c, and 18d that are provided on the carriage 14. Note that the fourth mounting hole (18d) is not shown in FIG. 1 because a portion of the carriage 14 has been removed for the purpose of illustrating the underlying bearings 16. Although FIG. 1 illustrates a carriage having four mounting holes 18a, 18b, 18c, and 18d, it is appreciated that a different number of mounting holes 18 may be provided on the carriage 14.

FIG. 2A illustrates a cross-sectional front view of an exemplary linear guide assembly 10 in accordance with one embodiment of the present invention. Exemplary mounting holes 18a and 18d are shown on the top surface of the carriage 14. It is appreciated that the depth and position of the mounting holes 18a and 18d are exemplary as these parameters may vary, depending on the application of the moving coil actuator. Rows of bearings 16a and 16b are shown positioned between the rail 12 and the carriage 14. As mentioned above, the bearings 16 facilitate smooth movement of the carriage 14 along the rail 12.

FIG. 2B is an expanded view of the row of bearings 16a illustrating contact points of the linear rail 12 and carriage 14 on the bearings 16. Arrows 20a-20d illustrate exemplary contact points of the rail 12 and carriage 14 on the bearings 16. As discussed in more detail below, the amount of pressure and stiffness at these contact points may affect the movement of the carriage 14 along the linear rail 12.

Optimal performance of the linear guide assembly 10 requires smooth and even movement of the carriage 14 along the rail 12. As moving coil actuators are employed in many applications that require precise guidance and low non-varying friction, there is minimal tolerance for deviations from optimal performance parameters. The present invention addresses two causes of such deviations: linear bearing stiffness and friction.

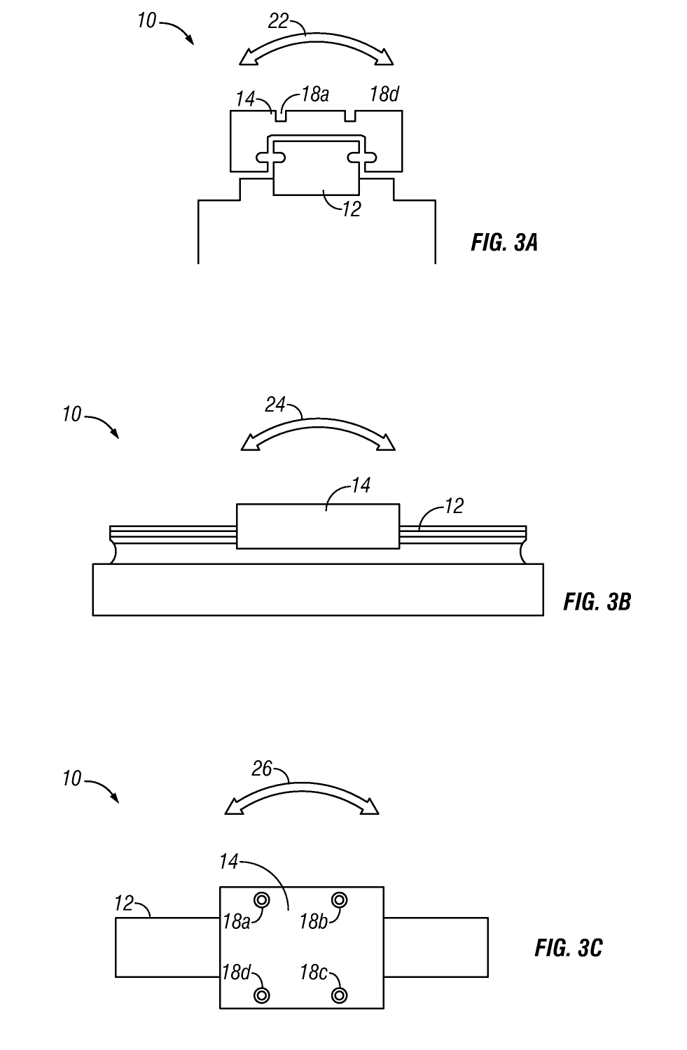

Linear bearing stiffness may be defined as the amount of carriage movement in three axes: roll, pitch, and yaw. FIG. 3A illustrates a front view of an exemplary linear guide assembly 10 in accordance with one embodiment of the present invention. Arrow 22 demonstrates roll movement of the carriage 14. FIG. 3B illustrates a side view of an exemplary linear guide assembly 10 in accordance with one embodiment of the present invention. Arrow 24 demonstrates pitch movement of the carriage 14. FIG. 3C illustrates a top view of an exemplary linear guide assembly 10 in accordance with one embodiment of the present invention. Arrow 26 demonstrates yaw movement of the carriage 14. Superfluous roll, pitch, and yaw movement of the carriage 14 may be attributable to excess clearance between the carriage 14, the bearings 16, and the linear rail 12.

Excess clearance may result in unpredictable control of the carriage position in a moving coil actuator, thereby detrimentally affecting the performance of the moving coil actuator, particularly in precision-sensitive applications. To restore the moving coil actuator to optimal performance, the effects of excess clearance may be reduced by increasing the stiffness of the linear guide assembly.

In contrast to excess clearance, friction may be caused by insufficient clearance between the carriage 14, bearings 16, and the linear rail 12. Friction may cause drag when the carriage 14 moves along the linear rail 12. For example, with reference to FIG. 1, when a bearing 16 enters the bearing channels of the carriage 14 and/or the linear rail 12, the revolution of the bearing 16 may momentarily cease due to narrowing of the bearing channels of the carriage 14 and/or linear rail 12. Insufficient clearance, in combination with narrowing of a bearing channel, may create such varying and unpredictable drag as to detrimentally affect a moving coil actuator's performance in precision-sensitive applications.

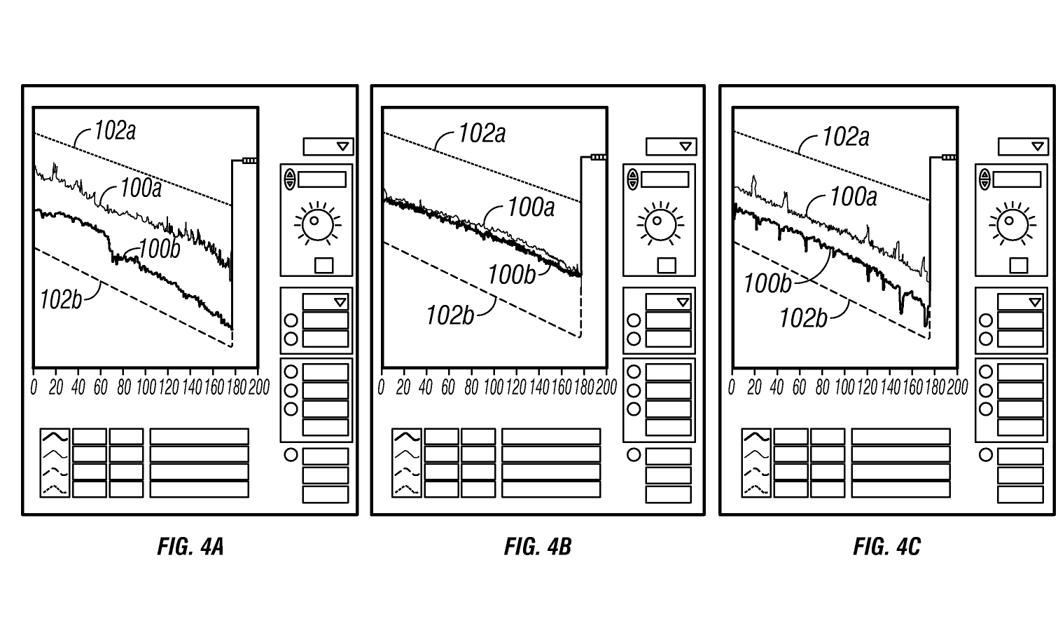

With reference to FIGS. 4A-4C, the spatial variation of the friction opposing the movement of a carriage 14 in a moving coil actuator may be demonstrated by plotting the current drawn by the actuator against the position of the carriage 14 on the linear rail 12. The vertical axes of the charts in FIGS. 4A-4C represent the current drawn by a moving coil actuator and the horizontal axes represent the position of the carriage 14 along the linear rail 12. The extension motion of a stroke consists of moving the carriage 14 from its original position at one end of the linear rail 12 to its final position at the other end of the linear rail. Similarly, the retraction motion consists of moving the carriage 14 from the latter position to the former position. Line 100a represents the current drawn as the carriage 14 completes an extension motion of a stroke and line 100b represents the current drawn as the carriage 14 completes a retraction motion of a stroke. In addition, lines 102a and 102b represent an exemplary theoretical target range, which set the boundaries of acceptable deviations from optimal performance. For the moving coil actuator to perform as intended, the lines 100a and 100b must fall between the theoretical target range defined between lines 102a and 102b during each stroke of the actuator. Note that lines 100a, 100b, 102a, and 102b in FIGS. 4A-4C are provided for explanatory purposes and it is appreciated that different current may be drawn and different theoretical ranges may be set in alternate embodiments of the moving coil actuator.

As variances in the friction opposing the movement of the carriage 14 will create coincident variances in the current drawn by the moving coil actuator, the frictional variances of a moving coil actuator are exemplified by the spikes in lines 100a and 100b of FIGS. 4A-4C. For example, FIG. 4A shows a number of spikes in lines 100a and 100b, indicating that the actuator experiences a significant amount of frictional variance through a stroke. Furthermore, FIG. 4A indicates that more current is needed to complete the extension motion of a stroke than the retraction motion of the stroke as line 100a is higher on the chart than line 100b. In contrast, FIG. 4B shows a moving coil actuator experiencing minimal frictional variance as lines 100a and 100b are generally free of relatively large spikes. FIG. 4B also indicates that the current drawn by the moving coil actuator in the extension stroke and the retraction stroke are approximately equal as both lines 100a and 100b are nearly overlapping. On the other hand, FIG. 4C represents a moving coil actuator experiencing substantial frictional variance as there are a number of relatively large spikes in the lines 100a and 100b. Such spikes may indicate that the bearings 16 are catching or snagging as they revolve in the bearing channels of the carriage 14 and/or rail 12. For optimal performance, it is desirable that the moving coil actuator approximates the ideal performance characteristics suggested by FIG. 4B, i.e., identical, variant-free current draws on the extension and retraction motions of a stroke.

To alleviate linear-bearing stiffness and friction, the linear guide assembly 10 may be preloaded by adjusting the clearance of the carriage 14. The preload may be performed on a micron level, for example, but smaller or larger degrees of preload may also be achieved.

In accordance with an exemplary embodiment of the present invention, placing micro-shims at particular locations on the carriage 14 surface may modify the physical characteristics of the linear guide assembly 10. For example, strategic placement of micro-shims on the surface of the carriage 14 enables modification of the stiffness or friction characteristics of the carriage 14. If a moving coil actuator is experiencing deviations from optimal performance as a result of excess or insufficient clearance between the carriage 14, the bearings 16, and the linear rail 12, a correctly placed micro-shim on the surface of the carriage 14 may ameliorate this deviation.

The micro-shims may comprise stripes of ink, such as indelible ink applied by a pen or marker, for example. In one embodiment of the present invention, the indelible ink is provided by permanent marker. When applied to the surface of the carriage 14, the particles in the indelible ink create a micro-shim. The thickness of this shim may be adjusted by varying the number of strokes of the marker over the same surface area. It is appreciated that other suitable types of ink or similar types of compositions may also be used as shims according to exemplary embodiments of the present invention.

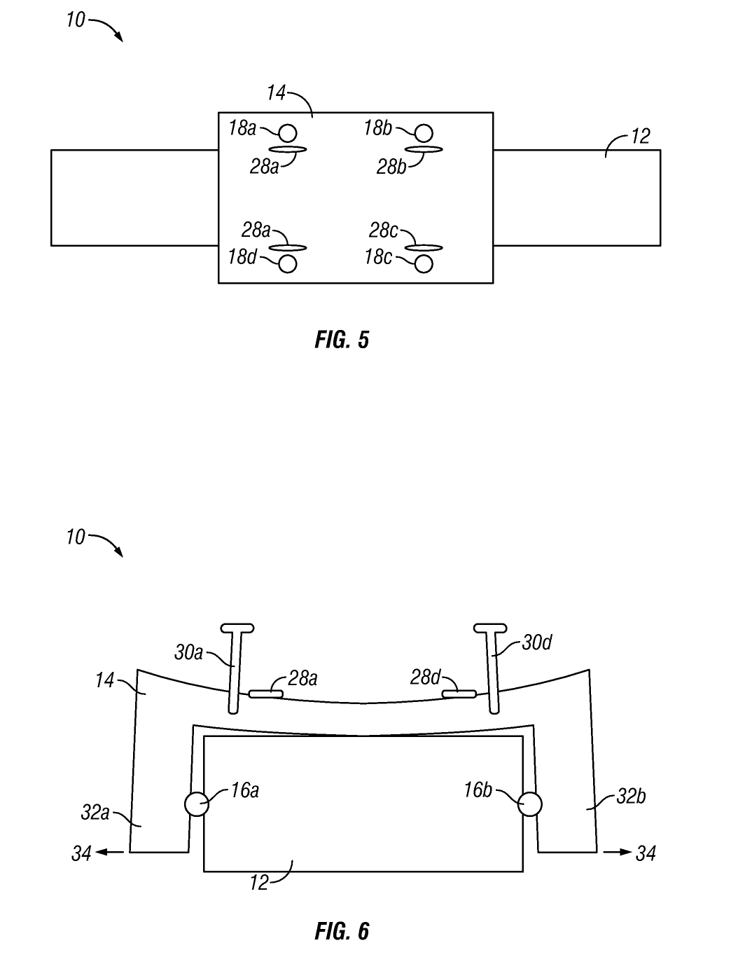

An exemplary preload process for correcting insufficient clearance between the carriage 14, the bearings 16, and the linear rail 12 is described with reference to FIGS. 5 and 6. As described above, insufficient clearance between the carriage 14, the bearings 16, and the linear rail 12 may create varying and unpredictable drag. As shown in FIG. 5, four micro-shims 28a-28d are placed between the mounting holes 18a-18d, respectively, and the center region of the carriage surface.

FIG. 6 is an exaggerated cross-sectional view of the linear guide assembly 10 after a mating component such as a piston (not shown), is clamped onto the carriage 14 with mounting screws 30a and 30b. As the component and carriage 14 are coupled, the presence of the micro-shims prevents direct contact of the component and carriage 14 in the region between the mounting screws 30a and 30b and the center region of the carriage surface. As no such obstacle exists in the regions between the mounting screws 30a and 30b and the edges of the carriage surface, direct contact between the component and the carriage 14 is achieved in those regions. Due to the different contact between the carriage 14 and the component in different regions of the carriage 14, fastening the mating component to the linear carriage 14 causes arms 32a and 32b of the carriage 14 to bow outwardly in the direction of arrows 34. This provides more clearance between the carriage 14, bearings 16, and rail 12, and, consequently, provides less variable and more predictable frictional characteristics.

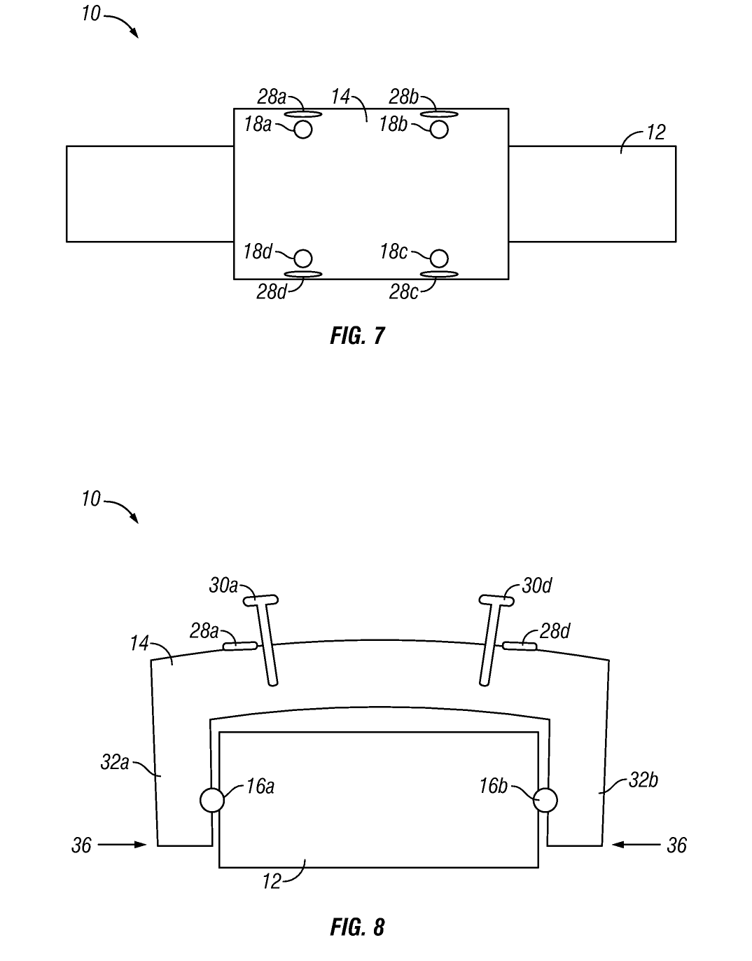

An exemplary preload process for correcting excess clearance between the carriage 14, the bearings 16, and the linear rail 12 is described with reference to FIGS. 7 and 8. As described above, excess clearance between the carriage 14, the bearings 16, and the linear rail 12 may result in unpredictable control of the carriage 14 in a moving coil actuator. As shown in FIG. 7, four micro-shims 28a-28d are placed between the mounting holes 18a-18d, respectively, and the edges of the carriage surface.

FIG. 8 is an exaggerated cross-sectional view of the linear guide assembly 10 after a mating component such as a piston (not shown), is clamped onto the carriage 14 with mounting screws 30a and 30b. As the component and carriage 14 are coupled, the presence of the micro-shims prevents direct contact of the component and carriage 14 in the region between the mounting screws 30a and 30b and the edges of the carriage surface. As no such obstacle exists in the regions between the mounting screws 30a and 30b, direct contact between the component and the carriage 14 is achieved in that region. Due to the different contact between the carriage 14 and the component in different regions of the carriage 14, fastening the mating component to the linear carriage 14 causes arms 32a and 32b of the carriage 14 to bow inwardly in the direction of arrows 36. This reduces clearance between the carriage 14, bearings 16, and rail 12, and, consequently, provides increased stiffness and, hence, accurate control of the carriage 14 on the linear rail 12.

As can be appreciated, varying the thickness of the shims 28 may vary the resulting amount of clearance and, hence, friction and stiffness. In general, the thicker the shims 28, the more the arm 32a and/or arm 32b of the carriage 14 will bow. When an indelible ink marker is used to apply the micro-shim, the thickness of each micro-shim may be varied by the number of times the marker is swiped over the particular location. In one embodiment, the thickness of the stripe 28 after a single swipe is about 1 to 2 microns and each additional swipe adds about 1 to 2 microns in thickness.

Furthermore, having some shims 28 thicker than other shims 28 may vary the performance of particular sections of the linear guide assembly 10. For example, referring to FIGS. 5 and 7, a relatively thicker shim 28a may cause the portion of the carriage 14 adjacent to the shim 28a to bow more than the other portions of the carriage 14. This may be beneficial if it is determined that one portion of the carriage 14 needs to bow more than the other portions to improve performance, for example.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but may be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead may be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A linear guide assembly, comprising:
a linear rail;
a carriage movably coupled to the linear rail, wherein the carriage comprises a mounting hole used for mounting a component on a surface of the carriage; and
a micro-shim located at a predetermined position on the surface of the carriage adjacent the mounting hole, wherein when the component is mounted on the surface of the carriage, the micro-shim adjusts a physical characteristic of the carriage in a desired manner so as to provide smoother movement of the carriage along the linear rail.

2. The apparatus of claim 1, wherein the linear guide assembly further comprises a plurality of bearings at an interface between the carriage and the linear rail.

3. The apparatus of claim 1 or 2, wherein the component further comprises a piston.

4. A linear guide assembly, comprising:
a linear rail;
a carriage movably coupled to the linear rail, wherein the carriage is configured to have a component mounted to a surface of the carriage; and
a micro-shim of indelible ink located at a predetermined position on the surface of the carriage, wherein when the component is mounted to the surface of the carriage, the micro-shim adjusts one or more physical characteristics of the carriage in a desired manner so as to provide smoother movement of the carriage along the linear rail.

5. The apparatus of claim 4, wherein the linear guide assembly further comprises a plurality of bearings at an interface between the carriage and the linear rail.

6. The apparatus of claim 4 or 5, wherein each micro-shim of indelible ink comprises at least one swipe of an indelible ink marker.

7. The apparatus of claim 6, wherein each swipe of the indelible ink marker has a thickness of 1-2 microns.

8. The apparatus of claim 4 or 5, wherein the component comprises a piston.

9. The apparatus of claim 8, wherein each micro-shim of indelible ink further comprises at least one swipe of an indelible ink marker.

10. The apparatus of claim 9, wherein each swipe of the indelible ink marker has a thickness of 1-2 microns.

11. A method for providing smoother movement of a carriage along the linear rail, comprising:
applying a micro-shim to a surface of the carriage, the micro-shim located at a predetermined position on the surface of the carriage; and
mounting a component to the carriage so that the micro-shim is positioned between the carriage and the component.

12. The method of claim 11, wherein the carriage has a mounting hole used for mounting the component to the carriage, wherein the micro-shim is applied between the mounting hole and an edge of the carriage surface if the linear guide assembly requires more stiffness for smoother movement, and wherein the micro-shim is applied between the mounting hole and a center region of the carriage surface if the linear guide assembly requires less friction for smoother movement.

13. The method of claim 11 or 12, wherein the component further comprises a piston.

14. The method of claim 11 or 12, wherein the linear guide assembly further comprises a plurality of bearings at an interface between the carriage and the linear rail.

15. The method of claim 14, wherein the component further comprises a piston.

16. In a linear guide assembly, comprising a linear rail and a carriage, the carriage movably coupled to the linear rail, wherein the carriage comprises a mounting hole used for mounting a component on a surface of the carriage, a method for providing smoother movement of the carriage along the linear rail, comprising:
applying a micro-shim of indelible ink to the surface of the carriage, the micro-shim located at a predetermined position adjacent to the mounting hole; and
mounting the component on the surface of the carriage so that the micro-shim is positioned between the carriage and the component.

17. The method of claim 16, wherein applying the micro-shim comprises applying the micro-shim between the mounting hole and an edge of the carriage surface to correct for a first physical characteristic, and applying the micro-shim between the mounting hole and the center region of the carriage surface to correct for a second physical characteristic.

18. The method of claim 16 or 17, wherein the component further comprises a piston.

19. The method of claim 18, wherein each micro-shim of indelible ink further comprises at least one swipe of an indelible ink marker.

20. The method of claim 17, wherein the first characteristic comprises an amount of friction present during sliding of the carriage along the linear rail and the second characteristic comprises an amount of stiffness of the carriage sliding along the linear rail.

21. The method of claim 16 or 17, wherein the linear guide assembly further comprises a plurality of bearings at an interface between the carriage and the linear rail.

22. The method of claim 21, wherein each micro-shim of indelible ink further comprises at least one swipe of an indelible ink marker.

23. The method of claim 22, wherein each swipe of the indelible ink marker has a thickness of 1-2 microns.

24. The method of claim 16 or 17, wherein the linear guide assembly further comprises a plurality of bearings at an interface between the carriage and the linear rail and the component further comprises a piston.

25. The method of claim 24, wherein each micro-shim of indelible ink further comprises at least one swipe of an indelible ink marker.

26. The method of claim 25, wherein each swipe of the indelible ink marker has a thickness of 1-2 microns.
